(19) United States
(12) Patent Application Publication
(10) Pub. No.: US 2015/0089876 A1
(43) Pub. Date: Apr. 2, 2015

(54) Garage Door Tracking Arrangements

(71) Applicant: Daylee Pty Ltd, Lake Munmorah (AU)

(72) Inventors: Gregory Brian James, Lake Munmorah (AU); Benjamin John Field, Lake Munmorah (AU)

(73) Assignee: DAYLEE PTY LTD, Lake Munmorah (AU)

(21) Appl. No.: 14/501,248

(22) Filed: Sep. 30, 2014

(30) Foreign Application Priority Data
Sep. 30, 2013 (AU) 2013903774

(51) Int. Cl. E05F 15/16; E05D 15/38; E05D 13/00; E05F 15/00

(52) U.S. Cl. CPC E05F 15/1646; E05F 15/00; E05D 15/38; E05D 13/145
USPC 49/349; 49/352; 49/447

(57) ABSTRACT

A carriage assembly is disclosed for a garage door drive belt. The assembly includes first and second carriage elements each having inner and outer members adapted to retain an end of the drive belt therebetween. An articulated connection extends between the first and second carriage elements. Also disclosed is a support arrangement for a garage door drive unit, comprising a drive unit hanger for attachment to a garage door structure, the hanger further having a weight-supporting connection to the drive unit, wherein the drive unit position is adjustable while the weight of the drive unit is supported.

### CROSS-REFERENCE TO RELATED APPLICATIONS

This application claims priority from Australian provisional patent application number 2013903774 filed on Sep. 30, 2013, which is hereby incorporated by reference in its entirety.

### BACKGROUND

1. Field

The present disclosure relates generally to overhead ‘garage’ doors, of the type used to close large openings in residential and commercial buildings. More particularly, the present disclosure relates to overhead doors of the sectional type, and to drive tracking arrangements and components for such doors.

2. Description of Related Art

Sectional garage doors are well known in the art. Although the design of sectional garage doors can significantly differ, certain components are common to such door systems. Thus a typical sectional garage door has a door curtain made of a plurality—usually four or more—panel sections hinged together at their longitudinal edges about horizontal hinge axes.

A pair of generally inverted L-shaped guide tracks is mounted to the building, one at each side of the door opening, with the vertical leg of the L being at the side of the door opening and the horizontal leg being above the level of the opening and extending back into the building space. The junction of the horizontal and vertical legs of the track is defined by a radius.

The door includes a plurality of rollers mounted on the opposite sides of the door sections, which follow the guide tracks to guide movement of the door curtain between a closed (lowered) position in which the door is vertical and closes off the door opening and an open (raised) position where the door is stored overhead in a horizontal orientation.

Since a sectional door is relatively large and heavy, it is commonplace to provide a counter-balancing spring system which loads up one or more torsion or extension springs as the door is lowered, so that the spring tension assists raising of the door. Such systems are commonly used even where the door is power operated.

A traditional counter-balancing system includes one or more torsion springs on a horizontal torsion shaft which is secured to the building structure above the door opening. The shaft has a cable drum with a cable connected to the bottom section of the door. As the door is lowered, the withdrawal of the cable causes the shaft to turn, winding up the torsion spring. The number and size of the springs is selected so that spring tension is selected to counterbalance part of the weight of the door, so that the door is easier to raise.

One type of power operator drive mechanism comprises a motor drive and belt drive arrangement mounted on a horizontal track suspended from the building structure above and behind the centre of the door opening, parallel to but above the plane of the horizontal legs of the L-shaped tracks, with a linkage connecting to the centre top of the sectional door. This arrangement requires additional fixing and increases the headroom required for the installation, ultimately reducing the height of the door that can be installed in situations where headroom is limited.

WO 2007/051237 and WO 2011/003152 disclose garage door arrangements which the torsion spring, and optionally the motor, is mounted on the door curtain, providing advantages in manufacture and installation.

WO 2013/016777 describes a garage door drive arrangement suitable for new installation or for retrofitting to an existing sectional door. The arrangement comprises a drive guide track fitted to one of the side door guide tracks, guiding a drive belt, with a linkage to the door curtain.

The arrangement of WO 2013/016777 provides a convenient and reliable garage door drive arrangement, but there are aspects which could be improved to improve performance and installation.

### SUMMARY

The present disclosure relates to a new and inventive drive apparatus for sectional garage doors, and aims to provide a drive apparatus which may be used either with the door arrangements of WO 2007/051237, WO 2011/003152 and WO 2013/016777, or with sectional garage doors of other types.

In one form, the present disclosure provides a carriage configuration for a garage door drive belt.

In a first aspect, there is disclosed a carriage member for a garage door drive belt, comprising first and second carriage elements, each carriage element comprising an inner member and an outer member adapted to retain an end of the drive belt therebetween, and an articulated connection between the first and second carriage elements.

In one example embodiment, each outer member has a bearing surface adapted to track along a drive belt guide track. Each carriage assembly may have a first end proximal the articulated connection and a second end distal from the articulated connection and through which the drive belt enters the carriage element, wherein the belt is captured between opposed belt-engaging surfaces of the inner and outer members.

The belt-retaining surface of the inner member may be notched to engage with a notched drive belt.

In a further example embodiment, the belt-retaining surfaces diverge from the bearing surface from the second end towards the first end of the carriage member. The bearing surface is preferably adapted to follow a convex bend in a guide track surface.

A further aspect of the disclosure provides a support arrangement for a garage door drive unit, comprising a drive unit hanger having means for attachment to a garage door structure, the hanger further having a weight-supporting connection to the drive unit, wherein the drive unit position is adjustable while the weight of the drive unit is supported.

The hanger may include a track providing weight-supporting connection while allowing positional adjustment of the drive unit.

Further aspects of the present disclosure will become apparent from the claims and from the illustrated embodiments and detailed description.

### BRIEF DESCRIPTION OF THE DRAWINGS

Further preferred embodiments of the present disclosure will now be described with reference to the accompanying drawings.

FIG. 1 is an elevation of an example drive track assembly for garage door installation according to one example embodiment of the present disclosure.

FIG. 2 is a perspective view of a drive belt carriage assembly according to one example embodiment of the present disclosure.

FIG. 3 is a cross-section of the carriage assembly of FIG. 2.

FIG. 4 shows the outer member of one carriage element of FIG. 2 being fitted over the inner member.

FIG. 5 shows an end assembly attached to one end of the drive guide track, in a further example embodiment, with the end assembly cover removed.

FIG. 6 is a perspective view of an adjustable tensioner assembly.

FIG. 7 shows the end assembly of FIG. 5 when fitted with the tensioner assembly of FIG. 6.

FIG. 8 shows the assembly of FIG. 8 with the cover in place.

FIG. 9 is an elevation of a drive unit hanger arrangement according to a further exemplary embodiment of the present disclosure,

FIG. 10 is a perspective view of the drive unit hanger arrangement of FIG. 9.

### DETAILED DESCRIPTION OF PREFERRED EMBODIMENTS

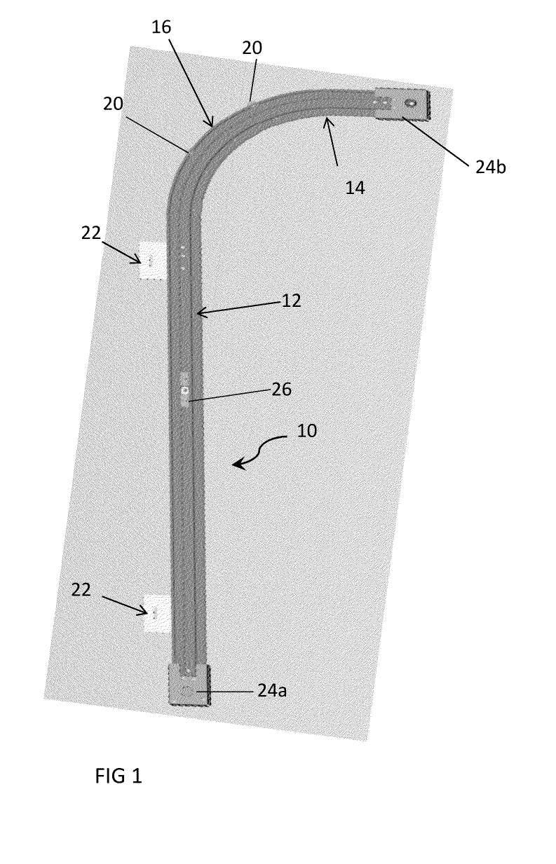

FIG. 1 is an elevation of a drive track assembly in accordance with one exemplary embodiment of the present disclosure.

The drive track 10 is of a general inverted L-shape, having a long vertical leg 12, a shorter horizontal leg 14 and a curved track section 16 between them.

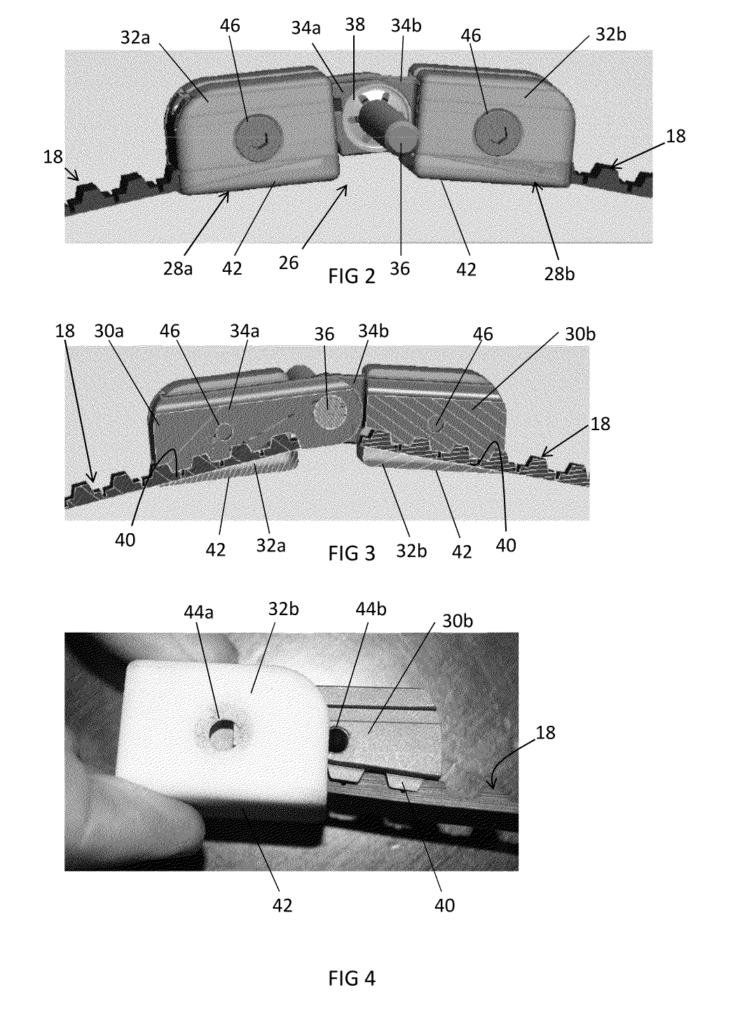

Each of the legs 12, 14 and curved section 16 consist of an extruded track section having channels for guiding a notched drive belt 18 (see for example FIGS. 2 to 5), guided by rollers 20.

The drive track 10 is adapted to be attached by brackets 22 to the door guide track (not shown) of the sectional garage door, to sit within the curve of the door guide track and generally in the plane of the guide track as described generally in WO 2013/016777.

The contents of WO 2007/051237, WO 2011/003152 and WO 2013/016777 are incorporated herein by reference.

At each end of the drive track is an end assembly 24a, 24b, more detail of which is described later in respect of FIGS. 5 to 8.

The belt drive 18 is formed into an endless loop, joined by means of an articulated carriage assembly 26 which is described below in respect of FIGS. 2 to 4.

FIGS. 2 to 4 show detail of the carriage assembly 26, which forms both a belt joiner and a guide for travel of the belt 18 along the drive track 10.

The carriage assembly 26 is made of two halves, 28a and 28b, each comprising an inner member 30a, 30b and an outer member 32a, 32b. The inner members 30a, 30b have overlapping portions 34a, 34b with aligned apertures, for receiving a connector pin 36 and retainer clip 38 for articulated connection of the two halves. The pin 36 may be extended to form a connection for a drive linkage to the sectional door curtain, to lift and lower the door curtain.

A lower surface 40 of the inner member is notched to match the profile of the drive belt 18, and also angled relative to the lower bearing surface 42 of the outer member 32, diverging in the direction approaching the articulated connection, for example by about 5 to 30 degrees, and more preferably about 8 to 20 degrees.

As shown in FIG. 4, in use the end of the drive belt 18 is fitted against lower surface 40 of the inner member 30 and the outer member 32 is then slid over, to capture and retain the belt 18 between the inner and outer members.

A locking screw 46 is passed through aligned holes 44a, 44b in the inner and outer members to lock the inner and outer members together and to thus retain the belt 18.

The same procedure is then repeated for the other half of the carriage, on the other end of the belt 18, after the belt has been cut to the length required for that installation. The connector pin 36 and retainer clip 38 may then be inserted to connect the two halves of the carriage together, to form the belt into an endless loop.

The taper of the belt retention surfaces relative to the bearing surface 42 helps lock the belt in place. A further advantage of the arrangement is to help maintain the belt at a relatively stable belt tension as the carriage follows the bend 16 of the drive track 10, thus helping reduce unnecessary strain on the drive motor.

FIG. 5 shows an end assembly for attachment to the guide track ends, including a body 44 formed of opposed halves, and a belt wheel 46 rotatably supported within the body which may be in the case of the bottom end assembly 24a be freewheeling, or in the case of the upper leg end assembly 24b, may be driven by a drive unit. The surface of belt wheel may be notched to match the notches of the drive belt 18.

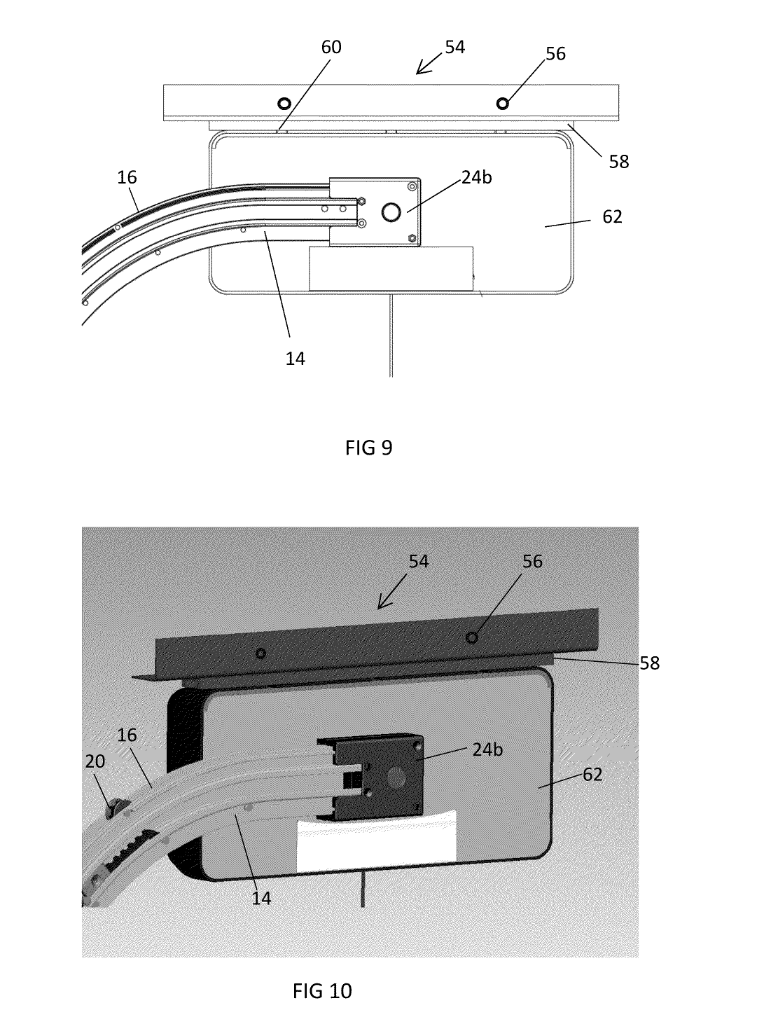

See FIGS. 9 and 10 and associated description below for more details of suspension of the drive unit.

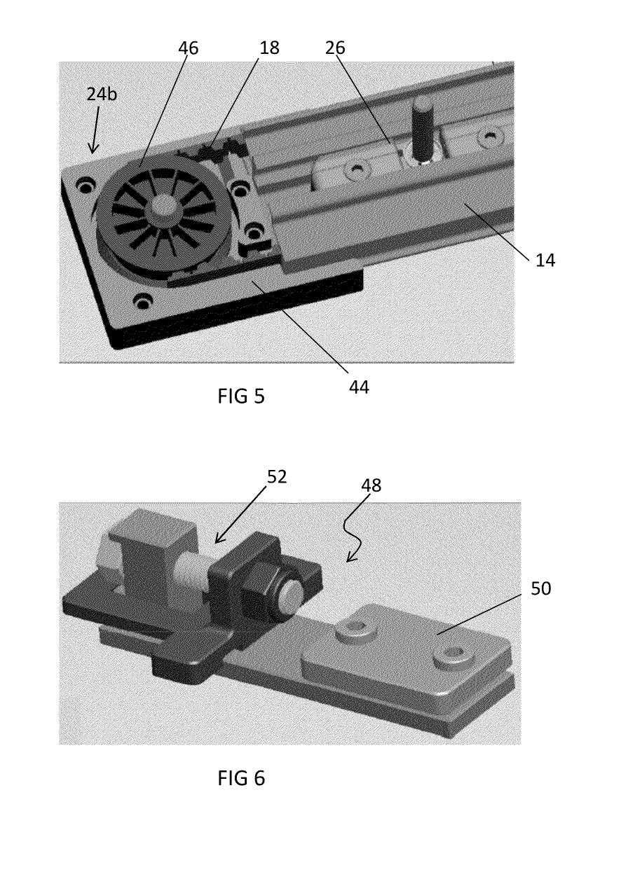

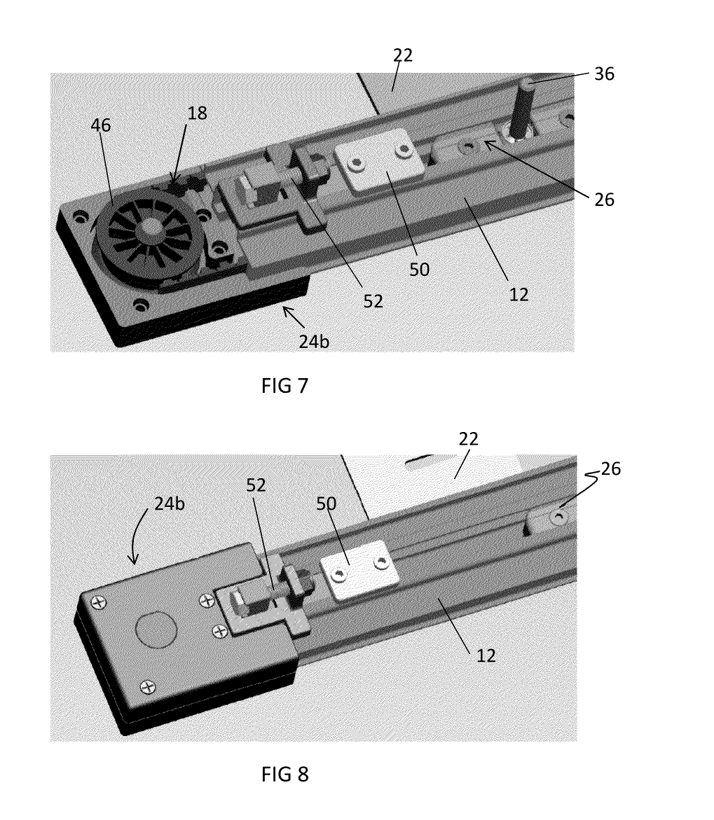

FIG. 6 illustrates an adjustable tensioner assembly 48, which is shown in FIGS. 7 and 8 fitted to the bottom end assembly 24b. The tensioner consists of a clamping plate 50 which is adapted to clamp to the drive track 12, and to provide an adjustable screw connection 52 bearing against end assembly 24b. This assists in adjustable tensioning of the belt 18, by adjusting separation of the end assembly from the track, against the tension of the drive belt 18.

In practice, an adjustment of less than 20 mm, or even less than 10 mm, may be sufficient adjustment for most installations. If greater adjustment is required, adjustable tensioners may be fitted to both the top and bottom end assemblies 24a, 24b, though it is believed that this will not normally be necessary.

FIGS. 9 and 10 illustrate a support arrangement for a drive motor unit for the garage door, adapted for greater ease of installation.

The support arrangement includes a hanger bracket 54 with boltholes 56 adapted for attachment for connection of the hanger to the garage door support structure, for example to the garage door track. The hanger 54 also includes a re-entrant track portion 58 running parallel to the garage door track to which it is connected, for receiving enlarged head pins 60 mounted on top of the drive unit housing 62.

In use, the support arrangement permits the hanger bracket to be connected to the door track and then attachment of the drive unit to the re-entrant track portion 58. The hanger bracket track 58 supports the weight of the drive unit, while finer adjustments to the drive unit to align with the end assembly 24b at the top end of the guide track may be made readily by the installer by sliding the drive unit along the support track 58, avoiding the need for the installer to bear the weight of the drive unit while making those fine adjustments.

The concepts of FIGS. 9 and 10 may also find application in the installation of drive units for other garage door arrangements, not just those described herein and in WO 2013/016777.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

It will be understood that the present disclosure extends to all alternative combinations of two or more of the individual features mentioned or evident from the text. All of these different combinations constitute various alternative aspects of the present disclosure.

While particular embodiments of the present disclosure have been described, it will be evident to those skilled in the art that the present disclosure may be embodied in other specific forms without departing from the essential characteristics thereof The present embodiments and examples are therefore to be considered in all respects as illustrative and not restrictive, the scope of the present disclosure being indicated by the appended claims rather than the foregoing description, and all changes which come within the meaning and range of equivalency of the claims are therefore intended to be embraced therein. It will further be understood that any reference herein to known prior art does not, unless the contrary indication appears, constitute an admission that such prior art is commonly known by those skilled in the art to which the present disclosure relates.

1. A carriage assembly for a garage door drive belt, the carriage assembly comprising:
first and second carriage elements, each carriage element comprising an inner member and an outer member adapted to retain an end of the drive belt therebetween; and
an articulated connection between the first and second carriage elements.

2. A carriage assembly according to claim 1, wherein:
each outer member has a bearing surface adapted to track along a drive belt guide track.

3. A carriage assembly according to claim 2, wherein:
each carriage element has a first end proximal the articulated connection and a second end distal from the articulated connection and through which the drive belt enters the carriage element, wherein the belt is captured between opposed belt-engaging surfaces of the inner and outer members.

4. A carriage assembly according to claim 3, wherein:
the belt-retaining surface of the inner member is notched to engage with a notched drive belt.

5. A carriage assembly according to claim 3, wherein:
the belt-retaining surfaces diverge from the bearing surface from the second end towards the first end of the carriage member.

6. A carriage assembly according to claim 2, wherein:
the bearing surface is adapted to follow a convex bend in a guide track surface.

7. A support arrangement for a garage door drive unit, comprising:
a drive unit hanger for attachment to a garage door structure, the hanger further having a weight-supporting connection to the drive unit, wherein the drive unit position is adjustable while the weight of the drive unit is supported.

8. The support arrangement of claim 7, wherein:
the hanger includes a track providing weight-supporting connection while allowing positional adjustment of the drive unit.

9. An apparatus for opening a garage door, the apparatus comprising:
a drive member operably coupled to the garage door;
first and second carriage elements, each carriage element comprising an inner member and an outer member adapted to retain an end of the drive belt therebetween; and
an articulated connection between the first and second carriage elements.
